(19) United States
(12) Patent Application Publication
(10) Pub. No.: US 2026/0258744 A1
(43) Pub. Date: Sep. 3, 2026

(54) EXHAUST SYSTEM

(71) Applicant: ISUZU MOTORS LIMITED, Yokohama-shi (JP)

(72) Inventor: Teppei OHORI, Fujisawa-shi (JP)

(21) Appl. No.: 19/464,730

(22) Filed: Jan. 30, 2026

(30) Foreign Application Priority Data
Mar. 3, 2025 (JP) 2025-032884

(51) Int. Cl. F01N 3/28; F01N 11/00

(52) U.S. Cl. CPC F01N 3/281; F01N 11/002; F01N 2340/06; F01N 2900/1402; F01N 2900/1404

(57) ABSTRACT

An exhaust system includes: an engine that obtains power by burning hydrogen; an exhaust manifold that includes a plurality of flow passage portions through which exhaust gas flows from a plurality of cylinders included in the engine, and a merging portion into which the plurality of flow passage portions merge; an exhaust pipe passage that communicates with the merging portion and through which the exhaust gas flows; and a plurality of third purification devices provided in the plurality of flow passage portions, and include a plurality of carriers on which a plurality of exhaust manifold catalysts for promoting oxidation reaction of hydrogen are supported.

### CROSS-REFERENCE TO RELATED APPLICATIONS

The present application claims priority to Japanese Patent Application number 2025-032884, filed on Mar. 3, 2025, contents of which are incorporated herein by reference in its entirety.

### BACKGROUND OF THE INVENTION

The present disclosure relates to an exhaust system. A conventional exhaust gas treatment system includes, in an exhaust passage through which exhaust gas from a lean-burn engine such as a diesel engine flows, an oxidation catalyst that purifies hydrocarbons (HC) and a reduction catalyst that reduces nitrogen oxides (NOx) (for example, Japanese Unexamined Patent Application Publication No. 2022-166099).

Exhaust gas from the lean-burn engine that uses hydrogen as fuel tends to contain unburned hydrogen. For this reason, hydrogen embrittlement may occur when a metal forming an exhaust passage absorbs the unburned hydrogen, and the exhaust passage may be damaged.

The present disclosure has been made in view of these points, and its object to reduce the amount of unburned hydrogen flowing through an exhaust passage.

### BRIEF SUMMARY OF THE INVENTION

An exhaust system according to an aspect of the present disclosure includes: an internal combustion engine that obtains power by burning hydrogen; an exhaust manifold that includes a plurality of flow passage portions through which exhaust gas flows from a plurality of cylinders included in the internal combustion engine, and a merging portion into which the plurality of flow passage portions merge; an exhaust pipe passage that communicates with the merging portion and through which the exhaust gas flows; and a plurality of catalysts that are provided in the plurality of flow passage portions and promote oxidation reaction of hydrogen.

### BRIEF DESCRIPTION OF THE DRAWINGS

FIG. 1 is a diagram showing an overview of an exhaust system 1.

FIG. 2 is a diagram showing an amount of N2O generated in an oxidation catalyst.

FIG. 3 is a diagram showing an exhaust gas temperature in an exhaust passage.

FIG. 4 is a diagram illustrating an overview of an exhaust system 1 according to a modification.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Overview of an exhaust system 1

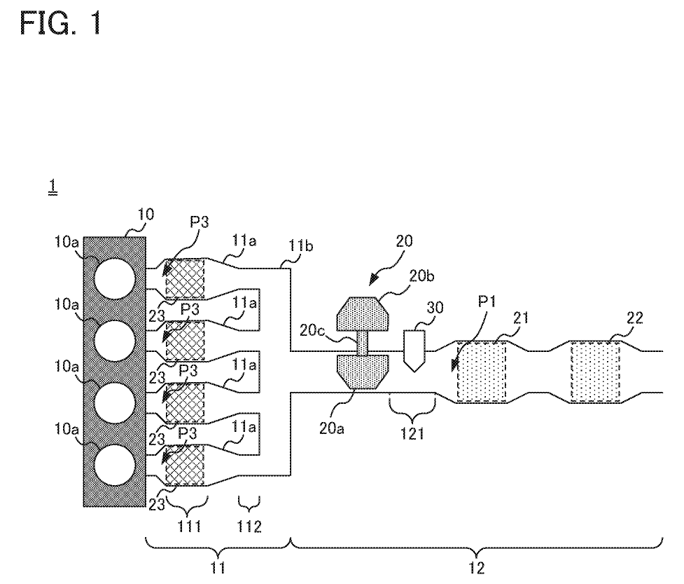

FIG. 1 is a diagram illustrating an overview of an exhaust system 1. The exhaust system 1 illustrated in FIG. 1 includes an engine 10, an exhaust manifold 11, an exhaust pipe passage 12, a supercharger 20, a first purification device 21, a second purification device 22, a plurality of third purification devices 23, and a sensor 30. The exhaust system 1 has a function of purifying exhaust gas from the engine 10.

The engine 10 is an internal combustion engine that obtains power by burning hydrogen. The engine 10 includes, for example, a plurality of cylinders 10a, and generates power by burning and expanding a mixture of hydrogen and intake air (air) in each cylinder 10a.

In the cylinder 10a, nitrogen and oxygen contained in intake air react with each other to generate nitrogen oxides (NOx). Further, in the cylinder 10a, hydrocarbon (HC) and carbon monoxide (CO) are generated by burning engine oil supplied to prevent seizure (so-called galling) between the cylinder 10a and a piston (not shown). Therefore, the engine 10 causes exhaust gas containing NOx, HC, and CO generated in the cylinder 10a to flow into the exhaust manifold 11.

The exhaust manifold 11 is a conduit that collects exhaust gas flowing from each cylinder 10a, and includes a plurality of flow passage portions 11a through which exhaust gas flows from the plurality of cylinders 10a included in the engine 10, and a merging portion 11b into which the plurality of flow passage portions 11a merge. The exhaust pipe passage 12 communicates with the merging portion 11b and is a conduit through which exhaust gas flows. The exhaust manifold 11 and the exhaust pipe passage are made of metal. In the following description, the exhaust manifold 11 and the exhaust pipe passage 12 may be collectively referred to as an “exhaust passage”.

The supercharger 20 is, for example, a turbocharger, and is a device that increases the density of intake air by using the flow of exhaust gas. The supercharger 20 includes a turbine 20a, a compressor 20b, and a connecting shaft 20c. The turbine 20a is provided downstream of the merging portion 11b and upstream of the first purification device 21 in the exhaust pipe passage 12, and rotates by receiving exhaust gas flowing through the exhaust pipe passage 12. The compressor 20b is connected to the turbine 20a via the connecting shaft 20c, and compresses intake air by rotating together with the turbine 20a. The compressor 20b is provided in an intake pipe passage (not shown) through which intake air flows.

The first purification device 21 is provided downstream of the turbine 20a in the exhaust pipe passage 12, and is a device for purifying the exhaust gas from the engine 10. The first purification device 21 houses an oxidation catalyst (OC). The oxidation catalyst, for example, oxidizes hydrocarbons contained in the exhaust gas from the engine 10 into water and carbon dioxide, and oxidizes carbon monoxide contained in the exhaust gas from the engine 10 into carbon dioxide.

The second purification device 22 is provided downstream of the first purification device 21 in the exhaust pipe passage 12, and is a device for purifying the exhaust gas from the engine 10. The second purification device 22 houses a selective catalytic reduction (SCR). In the selective catalytic reduction, for example, urea water injected from an injection unit (not shown) into an inlet of the second purification device 22 reacts with NOx contained in the exhaust gas, whereby the NOx is reduced to nitrogen and water.

The sensor 30 is one or more sensors provided downstream of the turbine 20a and upstream of the first purification device 21 (a position 121 shown in FIG. 1) in the exhaust pipe passage 12. The one or more sensors include, for example, at least one of (i) a temperature sensor for detecting the temperature of the exhaust gas or (ii) an NOx sensor for detecting the concentration of NOx contained in the exhaust gas.

When the engine 10 is a lean-burn engine, the mass of hydrogen relative to the mass of intake air is smaller than the mass of hydrogen at a stoichiometric air-fuel ratio (a so-called lean state), and therefore hydrogen does not readily propagate combustion in the cylinder 10a. Therefore, it is difficult to completely combust hydrogen, and unburned hydrogen tends to be contained in exhaust gas. As a result, hydrogen embrittlement may occur when the metal forming the exhaust passage absorbs hydrogen contained in the exhaust gas, and the exhaust passage may be damaged.

Therefore, in the exhaust system 1, the third purification device 23 is provided in each flow passage portion 11a located upstream of the exhaust passage. The third purification device 23 houses a catalyst (hereinafter, referred to as an “exhaust manifold catalyst”) for promoting oxidation reaction of hydrogen. With this configuration, the exhaust system 1 can purify exhaust gas by oxidizing hydrogen contained in exhaust gas in the flow passage portion 11a. As a result, the exhaust system 1 can reduce the amount of hydrogen contained in the exhaust gas downstream of the flow passage portion 11a, thereby suppressing hydrogen embrittlement of the metal forming the exhaust passage. Hereinafter, the configuration of the third purification device 23 that houses the exhaust manifold catalyst will be described.

### Configuration of the third purification device 23

The plurality of third purification devices 23 are provided in the plurality of flow passage portions 11a, and house a plurality of exhaust manifold catalysts for promoting the oxidation reaction of hydrogen. The exhaust manifold catalyst is, for example, platinum, palladium, or a platinum-palladium alloy. The third purification device 23 includes, for example, a honeycomb-structured carrier formed of metal, and the exhaust manifold catalyst is supported on the carrier. As described above, by having the carrier formed of metal having higher strength than ceramics, the third purification device 23 can reduce damage to the carrier even when the third purification device 23 is provided in the exhaust manifold 11 to which vibration of the engine 10 is readily transmitted.

The third purification device 23 (exhaust manifold catalyst) is provided at a position closer to the cylinder 10a than the merging portion 11b in the flow passage portion 11a. With this configuration, the exhaust system 1 can reduce unburned hydrogen flowing through the exhaust passage. In addition, the exhaust system 1 can reduce a region of the exhaust passage formed of metal in which hydrogen contained in the exhaust gas is readily absorbed. As a result, in the exhaust system 1, damaged to the exhaust passage is suppressed because hydrogen embrittlement is suppressed.

When hydrogen adheres to the sensor 30, erroneous detection or malfunction of the sensor 30 can occur. Therefore, in the exhaust system 1, the sensor 30 is provided at the position 121 in the exhaust pipe passage 12 which is provided downstream of the flow passage portion 11a in the exhaust passage. Specifically, in the exhaust pipe passage 12, downstream of the turbine 20a that rotates by receiving the exhaust gas, the exhaust system 1 further includes at least one of the temperature sensor for detecting the temperature of the exhaust gas or the NOx sensor for detecting the concentration of NOx contained in the exhaust gas.

By having the third purification device 23 provided in the flow passage portion 11a and the sensor 30 provided at the position 121 downstream of the flow passage portion 11a in the manner described above, the exhaust system 1 can purify hydrogen contained in the exhaust gas before the exhaust gas reaches the position 121. As a result, the exhaust system 1 can suppress erroneous detection of the sensor 30 and prevent malfunction of the sensor 30.

Further, in the oxidation catalyst housed in the first purification device 21, reaction between hydrogen and NOx is promoted, thereby facilitating generation of nitrous oxide (N2O), which has a higher greenhouse effect than carbon dioxide. Therefore, by having the third purification device 23 provided in the flow passage portion 11a as described above, the hydrogen contained in the exhaust gas can be purified before the exhaust gas reaches the first purification device 21, and therefore the exhaust system 1 can suppress the amount of N2O generated.

It should be noted that, since the exhaust manifold catalyst made of platinum, palladium, or a platinum-palladium alloy is an oxidation catalyst, reaction between hydrogen and NOx can generate N2O in the third purification device 23, as in the first purification device 21. However, N2O is readily generated as the temperature of exhaust gas containing hydrogen and NOx decreases. The temperature of the exhaust gas decreases at a position farther from the engine 10 in the exhaust passage.

Therefore, as described above, by having the third purification device 23 provided in the flow passage portion 11a connected to the engine 10, because the temperature of the exhaust gas flowing into an inlet P3 is difficult to decrease, the third purification device 23 can oxidize (purify) hydrogen while suppressing amount of N2O generated. Further, since the exhaust gas in a state in which hydrogen has been purified by the third purification device 23 reaches the first purification device 21, the first purification device 21 can suppress generation of N2O even when the temperature of the exhaust gas flowing in from an inlet P1 has decreased.

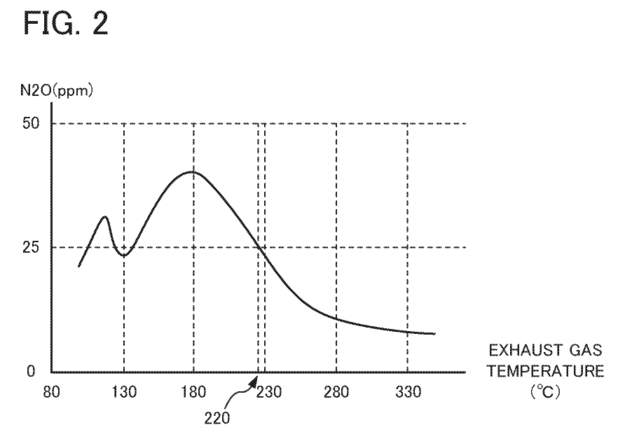

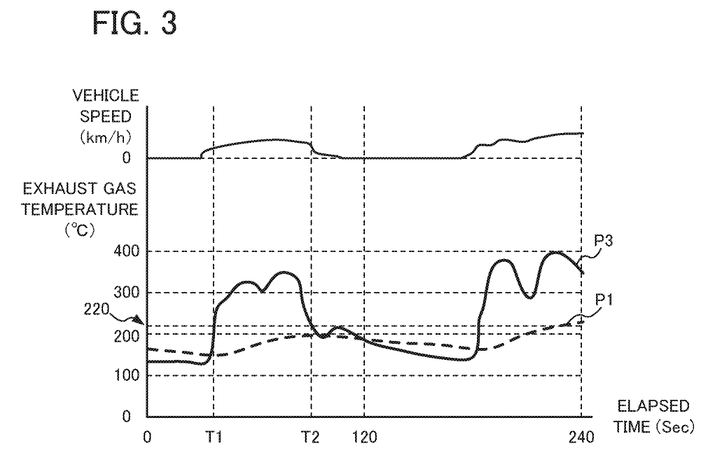

Hereinafter, the amount of N2O generated corresponding to the temperature of the exhaust gas at the inlet P3 and the inlet P1 will be described with reference to FIGS. 2 and 3. FIG. 2 is a diagram showing the amount of N2O generated in the oxidation catalyst. The horizontal axis of FIG. 2 indicates the exhaust gas temperature, and the vertical axis of FIG. 2 indicates the amount of N2O generated. As shown in FIG. 2, in the oxidation catalyst, when the exhaust gas temperature is lower than 220° C, N2O of 25 ppm or more is readily generated. On the other hand, when the exhaust gas temperature is 220° C or higher, N2O of less than 25 ppm is generated in the oxidation catalyst. The higher the exhaust gas temperature, the smaller the amount of N2O generated.

FIG. 3 is a diagram showing an exhaust gas temperature in an exhaust passage. The horizontal axis of FIG. 3 represents the elapsed time, and the vertical axis of FIG. 3 represents the vehicle speed and the exhaust gas temperature. FIG. 3 shows, as exhaust gas temperatures, an exhaust gas temperature (solid line) at the inlet P3 of the third purification device 23 and an exhaust gas temperature (broken line) at the inlet P1 of the first purification device 21. As shown in FIG. 3, from a time T1 to a time T2 during which the vehicle speed is higher than 0 (that is, when the engine 10 is driven), the exhaust gas temperature at the inlet P3 is a temperature (220° C or higher shown in FIG. 2) at which N2O of less than 25 ppm is generated. On the other hand, the exhaust gas temperature at the inlet P1 is a temperature (lower than 220° C shown in FIG. 2) at which NbO of 25 ppm or more is generated.

As described above, in a case where the exhaust gas at 220° C or higher, at which N2O is less likely to be generated, flows into the inlet P3, the third purification device 23 purifies hydrogen contained in the exhaust gas while suppressing the generation of N2O. Even if exhaust gas at less than 220° C, at which N2O is likely to be generated, flows into the inlet P1, the first purification device 21 can cause NOx contained in the exhaust gas to flow to the second purification device 22 without reacting with hydrogen, because the state of the exhaust gas is a state in which hydrogen has been purified. As a result, the first purification device 21 can suppress the generation of N2O. The generation of N2O corresponding to the temperature of the exhaust gas at the inlet P3 and the inlet P1 has been described above.

In the case where the third purification device 23 having the honeycomb-structured carrier is provided in the flow passage portion 11a, pressure loss of exhaust gas occurs downstream of the third purification device 23. Therefore, in the exhaust system 1, the hole diameter of the flow passage portion 11a may be increased. In the exhaust system b, for example, the hole diameter at a position 111 where the carrier is provided in the flow passage portion 11a is set to be larger than the hole diameter at a position 112 where the carrier is not provided in the flow passage portion 11a. With this configuration, the exhaust system 1 can prevent the occurrence of pressure loss of exhaust gas that would be caused by providing the honeycomb-structured carrier in the flow passage portion 11a.

### Modification

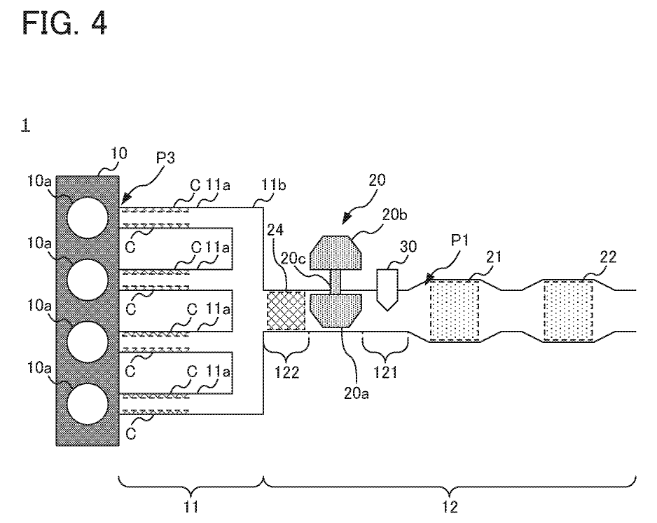

In the above description, the configuration in which the honeycomb-structured carrier is provided in the flow passage portion 11a and the exhaust manifold catalyst is supported on the carrier is exemplified, but the configuration is not limited thereto. The exhaust manifold catalyst may be supported on an inner wall surface of the exhaust passage. FIG. 4 is a diagram illustrating an overview of an exhaust system 1 according to a modification. The exhaust system 1 illustrated in FIG. 4 is different from the exhaust system 1 illustrated in FIG. 1 in that an exhaust manifold catalyst C for promoting oxidation reaction of hydrogen is supported on an inner wall surface of each flow passage portion 11a and that a fourth purification device 24 is provided, and is the same in other respects.

By supporting the exhaust manifold catalyst C on the inner wall surface of the flow passage portion 11a in a manner described above, the pressure loss of exhaust gas caused by providing the honeycomb-structured carrier in the flow passage portion 11a can be prevented. Further, in the flow passage portion 11a, even if the hole diameter at the position where the exhaust manifold catalyst C is supported and the hole diameter at the position where the exhaust manifold catalyst C is not supported are made the same, the pressure loss can be prevented.

In the case of supporting the exhaust manifold catalyst C on the inner wall surface of the flow passage portion 11a, since the area where the exhaust gas comes into contact with the exhaust manifold catalyst C becomes smaller than that in the case of providing the third purification device 23 in which the exhaust manifold catalyst C is supported on the honeycomb-structured carrier in the flow passage portion 11a, purification of hydrogen contained in the exhaust gas becomes more difficult. To address this, the exhaust system 1 illustrated in FIG. 4 includes the fourth purification device 24.

The fourth purification device 24 is provided upstream of the turbine and downstream of the merging portion 11b (a position 122 shown in FIG. 4) in the exhaust pipe passage 12, and includes a honeycomb-structured carrier. On the carrier, another catalyst for promoting oxidation reaction of hydrogen, which is different from the plurality of exhaust manifold catalysts C, is supported. The other catalyst is, for example, platinum, palladium, or a platinum-palladium alloy. The other catalyst may be the same component as that of the exhaust manifold catalyst C or may be a component different from that of the exhaust manifold catalyst C. With such a configuration, hydrogen that is not purified by the exhaust manifold catalyst C carried in the flow passage portion 11a can be purified upstream of the position 121 where the sensor 30 is provided in the exhaust pipe passage 12. As a result, erroneous detection of the sensor 30 and malfunction of the sensor 30 can be suppressed.

Further, the temperature of the exhaust gas flowing through the exhaust pipe passage 12 tends to decrease downstream of the turbine 20a. Therefore, by having the fourth purification device 24 provided upstream of the turbine 20a in this manner, hydrogen contained in the exhaust gas whose temperature has not been lowered can be oxidized (purified). As a result, the fourth purification device 24 can purify hydrogen while suppressing the generation of N2O. In addition, since exhaust gas in a state in which hydrogen has been purified by the fourth purification device 24 reaches the first purification device 21, it is possible to suppress the generation of N2O even if the temperature of the exhaust gas flowing in from the inlet P1 is lowered. In FIG. 4, a catalyst for promoting oxidation reaction of hydrogen may be further supported on the surface of the turbine 20a. With such a configuration, it is possible to increase the probability that the hydrogen contained in the exhaust gas can be purified.

### Effects by the exhaust system 1

As described above, the exhaust system 1 includes: the engine 10 that obtains power by burning hydrogen; the exhaust manifold 11 that includes the plurality of flow passage portions 11a through which exhaust gas flows from the plurality of cylinders 10a included in the engine 10, and the merging portion 11b into which the plurality of flow passage portions 11a merge; the exhaust pipe passage 12 that communicates with the merging portion 11b and through which exhaust gas flows; and the plurality of third purification devices 23 that are provided in the plurality of flow passage portions 11a, and include the plurality of carriers on which the plurality of exhaust manifold catalysts for promoting oxidation reaction of hydrogen are supported.

With this configuration, the exhaust system 1 can reduce unburned hydrogen flowing through the exhaust passage. In addition, the exhaust system 1 can reduce the region of the exhaust passage formed of metal in which hydrogen contained in the exhaust gas is readily absorbed. As a result, in the exhaust system 1, damage to the exhaust passage is suppressed by hydrogen embrittlement being suppressed. Furthermore, because hydrogen can be prevented from reaching the first purification device 21 (oxidation catalyst) provided in the exhaust pipe passage 12, the exhaust system 1 can suppress the reaction between hydrogen and NOx in the oxidation catalyst. As a result, the exhaust system 1 can suppress the generation of N2O.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. An exhaust system comprising:
an internal combustion engine that obtains power by burning hydrogen;
an exhaust manifold that includes a plurality of flow passage portions through which exhaust gas flows from a plurality of cylinders included in the internal combustion engine, and a merging portion into which the plurality of flow passage portions merge;
an exhaust pipe passage that communicates with the merging portion and through which the exhaust gas flows; and
a plurality of catalysts that are provided in the plurality of flow passage portions and promote oxidation reaction of hydrogen.

2. The exhaust system according to claim 1, wherein the catalyst is provided at a position closer to the cylinder than the merging portion in the flow passage portion.

3. The exhaust system according to claim 1, wherein the catalyst is supported on a honeycomb-structured carrier formed of a metal.

4. The exhaust system according to claim 3, wherein a hole diameter at a position where the carrier is provided in the flow passage portion is larger than a hole diameter at a position where the carrier is not provided in the flow passage portion.

5. The exhaust system according to claim 1, wherein a catalyst for promoting oxidation reaction of hydrogen is supported on an inner wall surface of the flow passage portion.

6. The exhaust system according to claim 1, further comprising:
a turbine that is provided in the exhaust pipe passage, is rotated by receiving the exhaust gas, and has, on a surface thereof, a catalyst supported for promoting oxidation reaction of hydrogen.

7. The exhaust system according to claim 1, further comprising:
a turbine that is provided in the exhaust pipe passage and is rotated by receiving the exhaust gas; and
another catalyst for promoting oxidation reaction of hydrogen that is provided upstream of the turbine in the exhaust pipe passage, and is different from the plurality of catalysts.

8. The exhaust system according to claim 1, further comprising:
at least one of a temperature sensor for detecting a temperature of the exhaust gas or an NOx sensor for detecting a concentration of NOx contained in the exhaust gas, provided in the exhaust pipe passage downstream of a turbine that is rotated by receiving the exhaust gas.
